(19) United States
(12) Patent Application Publication
(10) Pub. No.: US 2026/0254021 A1
(43) Pub. Date: Aug. 27, 2026

(54) Electric Energy Storage Device, Motor Vehicle, and Method for Producing an Electric Energy Storage Device

(71) Applicant: Bayerische Motoren Werke Aktiengesellschaft, Muenchen (DE)

(72) Inventor: Simon WUERZINGER, Wildenberg (DE)

(21) Appl. No.: 18/879,451

(22) PCT Filed: Aug. 9, 2023
(86) PCT No.: PCT/EP2023/072004

§ 371 Date: Dec. 27, 2024

(30) Foreign Application Priority Data
Sep. 6, 2022 (DE) 10 2022 122 484.8

(51) Int. Cl. H01M 50/24; H01M 10/613; H01M 10/625; H01M 50/213; H01M 50/249; H01M 50/262; H01M 50/289

(52) U.S. Cl. CPC H01M 50/24; H01M 10/613; H01M 10/625; H01M 50/213; H01M 50/249; H01M 50/262; H01M 50/289

(57) ABSTRACT

An electric energy storage device includes a housing, which has a housing upper part and a housing lower part, and a plurality of energy storage cells, which are integrated into a foam structure. The upper face of the foam structure is foamed onto the housing upper part, and the lower face of the foam structure is foamed onto a fluid-tight assembly surface of a support structure, which is arranged between the foam structure and the housing lower part. The foam structure has lateral surfaces that are shaped via the contoured section of a tool and/or by the process of being foamed onto one or more lateral walls, which are connected to the support structure in a fluid-tight manner, when the foam structure is produced.

### BACKGROUND AND SUMMARY

The present invention relates to an electric energy storage device, to a motor vehicle, and to a method for producing an electric energy storage device.

Electric energy storage devices of the type discussed herein are used in partially or fully electrically powered motor vehicles such as, for example, passenger motor vehicles. Energy storage devices of this type are typically very large and often occupy large regions of the underbody in passenger motor vehicles. The construction of energy storage devices of this type is often difficult because a very large number of energy storage cells has to be installed. The latter have to be electrically contacted and cooled during operation. Additionally, safety requirements of the highest order have to be met at low production costs.

It is therefore an object of the present invention to specify an electric energy storage device, a motor vehicle, and a method for producing an electric energy storage device, whereby the production of energy storage devices of the highest quality is to be enabled at low cost.

This object is achieved by an electric energy storage device, by a motor vehicle, and by a method according to the independent claims. Further advantages and features are derived from the dependent claims and from the description and the appended figures.

According to the invention, an electric energy storage device comprises a housing which has a housing upper part and a housing lower part, and a multiplicity of energy storage cells which are embedded in a foam structure, wherein the foam structure, by way of its upper side, is foam-bonded to the housing upper part, and by way of its lower side, is foam-bonded to a fluid-tight arrangement surface of a support structure which is disposed between the foam structure and the housing lower part; and wherein the foam structure has lateral faces which when generating the foam structure are formed by way of a tool contour and/or by foam-bonding to one or a plurality of lateral walls which are connected to the support structure in a fluid-tight manner. The foam structure is thus expediently generated directly “in the product”. According to a preferred embodiment, the foam structure here does not completely fill the housing but is only provided where the foam structure is actually required. When viewed along a vertical axis, wherein the latter is oriented perpendicularly to a road surface plane, or the arrangement surface, the foam structure is adjacent to the housing upper part. Opposite thereto, thus toward the bottom, the foam structure is adjacent to the arrangement surface of the support structure. The latter here is expediently designed to be fluid-tight. It is advantageously achieved in this way that a foaming-capable medium, in particular a foaming-capable fluid, can be poured onto the arrangement surface. The media/materials used for this purpose are typically very effusive. This is presently not problematic because the arrangement surface does not have any holes, clearances or the like, thus is particularly fluid-tight. Therefore, foaming “from bottom to top” is expediently possible. The arrangement surface, conjointly with the tool contour(s) and/or the lateral walls, which are likewise disposed in a fluid-tight manner, forms a cavity in which the foaming-capable material can be incorporated. The lateral walls and/or the at least one tool contour advantageously delimit the cavity. The foam structure is merely foam-bonded to the housing upper part, but not to the housing lower part, which is advantageous, inter alia, with a view to being able to dismantle the housing. Moreover, advantages are also derived directly during the production of the electric energy storing device, because the latter does not have to be turned during production, or for foaming, which would be problematic due to the large number of installed energy storage cells and the size of the storage device.

It is to be mentioned at this point that round cells, in particular cylindrical round cells, are preferably used as energy storage cells. The longitudinal axis of the latter is oriented along the above-mentioned vertical axis. Alternatively, however, other housing shapes may also be used, such as, for example, prismatic housings, etc.

According to one embodiment, the energy storage cells are disposed so as to be spaced apart from the arrangement surface by way of a multiplicity of spacer elements. The energy storage cells can be disposed indirectly or directly on the arrangement surface. They are preferably disposed indirectly by way of the aforementioned spacer elements. These spacer elements are expediently conceived in such a manner that an intermediate space or gap is formed between the actual arrangement surface and the lower side of the energy storage cells, which intermediate space or gap is, for example, between 1 and 5 mm, preferably approximately 2 to 3 mm, depending on the embodiment. The degassing valve of the energy storage cells is expediently positioned on the aforementioned lower side of the energy storage cells. Therefore, the foam structure forms a more or less thin layer below the energy storage cells, which more or less thin layer can be penetrated in the case of a thermal event, thus in the case of an out-of-control energy storage cell. Therefore, the energy storage cell can expediently be degassed toward the bottom. The required dissipation of pressure here is expediently achieved by way of the design embodiment of the aforementioned support structure. The spacer elements advantageously enable a defined foam insulation of the energy storage cells.

The support structure is expediently an element made of a foamed plastics material. The support structure is expediently a board with a thickness of approximately 2 to 8 cm. The board is preferably made of a foamed plastics material and expediently has a multiplicity of ducts, clearances, holes and the like. These ducts, clearances, etc., enable a targeted dissipation of pressure when one or a plurality of energy storage cells are out-of-Attorney control. At the same time, the support structure protects the energy storage cells from below. According to one embodiment, the support structure is disposed indirectly or directly on the housing lower part. Should the motor vehicle bottom out on an obstacle such as, for example, a curb or the like, the loads arising in the process can be received or absorbed by way of the support structure. Accordingly, the material of the support structure is expediently softer and more flexible than the substance or the material of the foam structure in which the energy storage cells are embedded.

According to a preferred embodiment, an additional element is disposed on the support structure. According to one embodiment, the additional element shapes or forms the arrangement surface. The additional element is expediently conceived to enable a distribution of load in the plane of the arrangement surface, or perpendicularly to the vertical axis. Accordingly, the additional element can be understood to be, and referred to as, a load distribution board. According to one embodiment, the additional element is a board which has a thickness of a few millimeters, for example 2 to 8 mm, whereby the aforementioned dimensions may vary upward or downward. According to one embodiment, a plastics material is used as the material for the additional element. The additional element is disposed on the support structure, or fastened to the latter, for example, adhesively bonded thereto. The additional element is expediently a closed board which does not have any clearances or holes, thus is in particular fluid tight. Accordingly, the arrangement surface is a closed fluid-tight plane. The additional element, as well as the aforementioned intermediate layer of the foam structure, are advantageously conceived in such a manner that they can be penetrated in the case of a thermal event. The pressure can be distributed within the ducts of the support structure, or be dissipated therein. A precise and repeatable foaming installation of the energy storage cells can advantageously be achieved by way of the spacer elements, in particular also in the region of the degassing valves of the energy storage cells. If an additional element is disposed on the arrangement surface, the spacer elements are preferably integrated into this additional element. In this instance, the additional element preferably comprises the spacer elements, or forms the latter.

According to a preferred embodiment, the support structure is connected in a materially integral manner, in particular adhesively bonded, to the, in particular tub-shaped, housing lower part. The housing lower part is expediently connected to the housing upper part in a form-fitting and/or force-fitting manner. According to one embodiment, the housing lower part is riveted and adhesively bonded to the housing upper part. The fastening is expediently chosen in such a manner that a gas-tight fastening or connection is achieved.

According to one embodiment, the energy storage device comprises two, in particular mutually opposite, lateral walls which extend along the vertical axis, wherein a first lateral wall has means for conducting coolant, and wherein a second lateral wall has means for conducting an electric current. According to one embodiment, the energy storage cells are disposed next to one another in a multiplicity of rows. Cooling elements are disposed between the rows. In the case of cylindrical round cells, these cooling elements are preferably wave-shaped. According to one embodiment, the cooling elements, which according to one preferred embodiment are formed from a metallic material and shaped from an extruded profile, have means for conducting the fluid in one direction as well is in the respective other direction. The supply of coolant and the discharge of coolant can accordingly take place from the same side. According to one embodiment, ducts for supplying and discharging a coolant into the cooling elements and out of the latter are accordingly disposed in the first lateral wall.

A contacting system, in particular an electric cell contacting system, which is conceived and specified to electrically contact the energy storage cells, in particular to wire the latter as well as monitor the latter by sensors, etc., is expediently provided on the energy storage cells, in particular thus between the upper housing part and an upper side of the energy storage cell. The current path is expediently constructed in such a manner that the latter is enabled by way of the second lateral wall which correspondingly preferably has means for conducting the electric current, etc.

According to a preferred embodiment, the support structure is assembled, or in particular interlocked, in particular in a fluid-tight manner, from a multiplicity of segments. Expediently, the support structure therefore does not have to be formed in one piece, which would often be able to be implemented only with difficulty due to the size of energy storage devices of this type. According to one embodiment, the support structure has, for example, a quadrangular shape, in particular a rectangular shape. The short side herein is between 1 and 2 m, for example, while the longer side is between 1.5 and 3.5 m, for example. Owing to the fact that the support structure consists of a multiplicity of segments, this support structure is significantly easier to produce.

According to one embodiment, energy storage cells, for example, one or a plurality of rows of energy storage cells, are (already) disposed on the individual segments of the support structure. Cooling elements are expediently also already provided/disposed. Furthermore alternatively, portions of the lateral wall, or of the lateral walls, can already be disposed. According to one embodiment, additional element portions are also disposed on the individual segments of the support structure. The aforementioned cavity, in particular the fluid-tight cavity, can expediently be assembled or interlocked.

According to one embodiment, the lateral walls, or at least one lateral wall, are/is also assembled in a fluid-tight from a multiplicity of portions.

According to one embodiment, cutting elements and/or form-fitting elements for establishing the fluid-tight connection are formed between or on the segments/portions. Cutting elements can be designed, for example, as knife edges or the like, which are conceived to cut into the material of the respective other portion or of the respective other segment, or else into the additional element, so that a fluid-tight connection between the portions, segments, etc., is created. The aforementioned parts can also be in mutual contact by way of form-fitting elements in such a manner that a fluid-tight connection is created.

The invention is also directed toward a motor vehicle which comprises at least one electric energy storage device according to the invention. Motor vehicles of the type discussed are in particular land vehicles such as motorcycles, passenger motor cars or else commercial vehicles.

The invention is furthermore directed to a method for producing an electric energy storage device, comprising the following steps:
providing a support structure, wherein the support structure has a fluid-tight arrangement surface;
disposing a multiplicity of energy storage cells on the arrangement surface;
disposing in a fluid-tight manner one or a plurality of lateral walls on the support structure and/or using one or a plurality of tools for shaping a cavity for a foam structure for embedding the energy storage cells;
incorporating a foaming-capable fluid or medium into the cavity;
closing the cavity by disposing a housing upper part of the energy storage device.

According to one embodiment, the support structure is disposed on a workpiece carrier. According to one embodiment, in a next step an additional element is disposed on the support structure, and the energy storage cells are disposed on the additional element. A (cell) contacting system for electrical contacting is disposed on the energy storage cells. By way of the fluid-tight design of the arrangement surface as well as the fluid-tight disposal of one or a plurality of lateral walls and/or of the tool contours, it can be advantageously made possible to foam directly onto the arrangement surface. The lateral walls, the tool contours, the housing upper part and the arrangement surface herein shape the cavity, the latter determining the shape of the foam structure.

By disposing one or a plurality of lateral walls on the support structure and/or by disposing one or a plurality of tools, conjointly with the support structure or the arrangement surface, a cavity into which the foaming-capable material can be incorporated is shaped. Once the medium has been incorporated, the cavity is closed by disposing the housing upper part. The foaming-capable material now fills the cavity, whereby the housing upper part is foam-bonded just like the optionally present lateral walls and/or else the arrangement surface.

According to one preferred embodiment, the method comprises the following step:
assembling the support structure from a multiplicity of segments.

It is to be pointed out here that the advantages and features mentioned in the context of the electric energy storage device also apply in an analogous manner to the method, and vice versa.

According to a preferred embodiment, energy storage cells are disposed on the segments. Expediently, cooling elements or a lateral wall portions are additionally also disposed. The support structure, as well as the arrangement surface, or also the additional element as well as the lateral portions are expediently thus assembled from individual portions, parts or segments. According to one embodiment the additional element is also formed from a multiplicity of individual parts/portions. According to one embodiment, the aforementioned segments of the energy storage cells already have the individual parts of the additional element.

According to one embodiment, the method comprises the following step:
connecting in a fluid-tight manner the segments, the lateral walls and/or the portions by envisaging form-fitting and/or cutting elements which are conceived to provide fluid-tightness between the components, segments and/or portions.
The fluid-tightness here is expediently always designed in such a manner that a foaming-capable material or medium can be incorporated in or on the arrangement surface or the formed cavity, so that foaming is possible, in particular from bottom to top. As has already been mentioned, the support structure expediently has ducts, clearances and the like. It is ensured, inter alia, by way of the fluid-tight arrangement surface that these ducts, clearances and the like are not injected with foam.

According to one embodiment, the method comprises the following step:
connecting in a materially integral manner the housing lower part of the energy storage device to the support structure.

According to one embodiment, the housing lower part is in particular adhesively bonded to the support structure.

Further advantages and features are derived from the description hereunder of an embodiment of the energy storage device and of the method with reference to the appended figures.

In the figures:

### BRIEF DESCRIPTION OF THE DRAWINGS

FIG. 1 shows a top view of an embodiment of a support structure in a schematic illustration;

FIG. 2 shows the section A-A has indicated in FIG. 1;

FIG. 3 shows the arrangement known from FIG. 2 in a next process step;

FIG. 4 shows a schematic detailed illustration of an energy storage cell which is disposed on an arrangement surface;

FIG. 5 shows two schematic views of support structure segments; and

FIG. 6 shows an embodiment of two support structure segments for producing a fluid-tight connection.

### DETAILED DESCRIPTION OF THE DRAWINGS

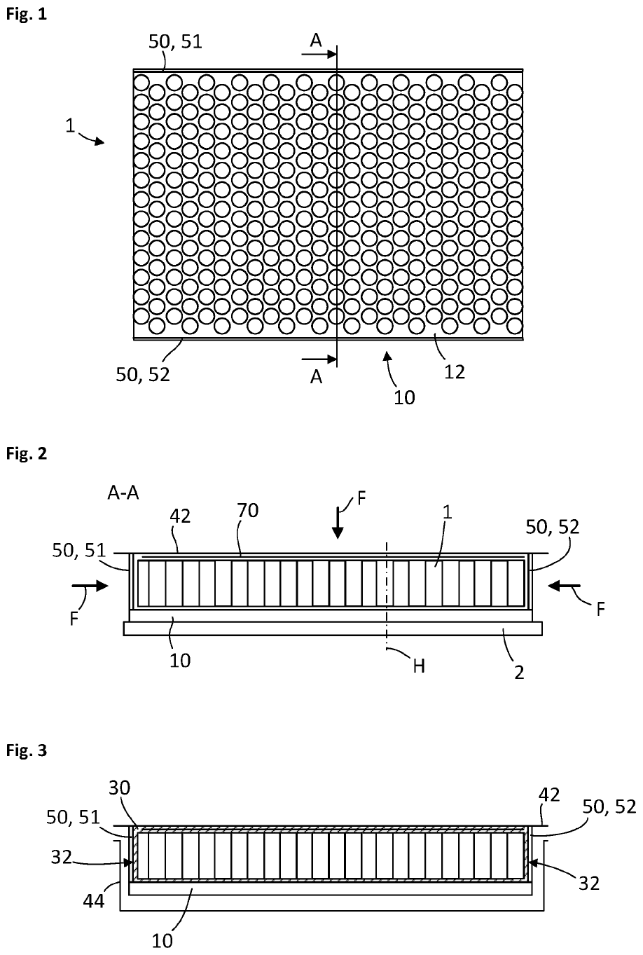

Shown in FIG. 1 is a schematic top view of an embodiment of the support structure 10. The latter comprises an arrangement surface 12 on which a multiplicity of energy storage cells 1 are presently disposed. The energy storage cells 1 are cylindrical round cells which are disposed upright on the arrangement surface 12. Lateral walls 50, in particular a first lateral wall 51 and a second lateral wall 52, are disposed on two sides of the support structure 10. The section A-A is illustrated in FIG. 2.

FIG. 2 shows the section A-A indicated in FIG. 1, wherein presently further components are also added. It is illustrated in particular that the support structure 10 is disposed on a tool carrier 2. The energy storage cells 1 extend along a vertical axis H. Oriented along the latter are also the lateral walls 50, 51 and 52, respectively. A contacting system 70 is disposed on the energy storage cells 1. This contacting system 70 is conceived and provided to electrically contact the energy storage cells 1 among one another, to provide sensor signals, etc. According to one embodiment, the current path is established, for example, by way of the second lateral wall 52 which has corresponding means for electrically connecting and contacting. It can be seen that the two lateral walls 51 and 52, conjointly with the support structure 10 or the arrangement surface 12 (wherein the latter here is no longer provided with the reference sign for reasons of clarity), form a cavity for shaping a foam structure. This “cavity” is completed by the disposal of a housing upper part 42. Before the housing upper part 42 is disposed, the medium to be foamed is expediently applied, for example, poured, onto the support structure 10. Subsequently, the housing upper part 42 is placed thereon, and the cavity present between the energy storage cells 1 is injected with foam. In the process, the housing upper part 42, the lateral walls 51 and 52, the support structure 10, or the arrangement surface 12, and on those sides where no lateral walls 50 are provided, corresponding tool contours act as borders. It is indicated in FIG. 2 that closing forces are applied here by way of tools which are not illustrated in more detail, cf. the arrows with the reference signs F which support the housing upper part 42 and/or the lateral walls 50 etc., in the foaming process.

FIG. 3 shows a state in which a foam structure 30 has been generated. It can be seen that the housing upper part 42 has been foam-bonded. A housing lower part 44 can now be fastened to the housing upper part 42. According to one preferred embodiment, the housing lower part 44 is fastened to the support structure 10 by means of adhesive bonding. With reference to FIGS. 1 to 3 it can be readily seen that the entire arrangement does not have to be turned or rotated for producing the foam structure 30. Instead, a defined foaming process can be achieved, which can be implemented with little complexity.

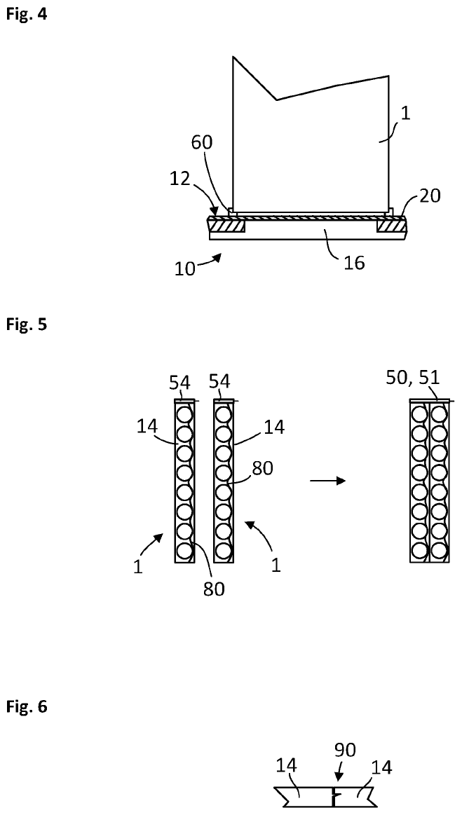

FIG. 4 in a schematic, enlarged detailed view shows an embodiment of an energy storage cell 1. The latter is disposed on an arrangement surface 12. The arrangement surface 12 is presently formed by an additional element 20 which is disposed on a support structure 10. It can be seen that the energy storage cell 1 is not disposed directly on the arrangement surface 12 but indirectly by way of spacer elements 60. An intermediate space is thus formed between the energy storage cell 1 and the arrangement surface 12. This intermediate space is filled with foam when insulating the energy storage cell with foam. The support structure 10 comprises one or a plurality of ducts 16. The degassing valve of the energy storage cells is typically provided on the lower side of the latter. Should a thermal event occur, the foam intermediate layer below the energy storage cell 1 as well as the additional element 12 are penetrated, and the pressure is directed into the support structure 10. Defined insulating of the energy storage cells 1 with foam can be implemented by way of the spacer elements 60.

FIG. 5 shows two support structure segments 14 in a schematic view, wherein each support structure segment comprises one row of energy storage cells 1. A wave-shaped cooling element 80 is in each case already disposed on the row of energy storage cells 1. Both support structure segments 14 here comprise in each case lateral wall portions 54. The lateral wall portions 54 are in each case connected in a fluid-conducting manner to the cooling elements 80. In other words: the lateral wall portions 54 comprise means for conducting coolant. It can be derived from the right half of the image that the segments 14 can be assembled or interlocked. This applies in a similar manner also to the lateral wall portions 54 which now schematically shape a first lateral wall 51. In this way, a large arrangement of energy storage cells, such as shown in the diagram of FIG. 1, for example, can be “joined up”. It is decisive here that the support structure segments 14 are connected to one another in a fluid-tight manner. This applies in a similar manner also to an additional element which is optionally disposed thereon, such as the additional element shown in the diagram of FIG. 4, for example. According to one embodiment, the additional element can also be a single planar board which is disposed on the corresponding segments 14. Expediently, the lateral wall portions 54 are also connected to one another, or toward the support structure segments 14, in a fluid-tight manner. The same applies when the lateral wall portions 54 are conceived to shape a lateral wall which has means for conducting an electric current.

FIG. 6 shows a schematic view comprising two support structure segments 14 which have cutting elements 90. Fluid-tight connections, which enable foaming within the product, can be produced between the portions, segments, parts and the like by way of cutting elements 90 of this type, which are designed in the manner of a knife blade, as in the present case, and/or else by way of correspondingly designed form-fitting elements.

### LIST OF REFERENCE SIGNS

1 Energy storage cell
2 Tool carrier
10 Support structure
12 Arrangement surface
14 (Support structure) segment
16 Duct
20 Additional element, Load distribution element
30 Foam structure
32 Lateral face
40 Housing
42 Housing upper part
44 Housing lower part
50 Lateral wall
51 First lateral wall
52 Second lateral wall
54 (Lateral wall) portion
60 Spacer element
70 Contacting system
80 Cooling element
90 Cutting element
F Force
H Vertical axis

1.-15. (canceled)

16. An electric energy storage device comprising:
a housing which includes a housing upper part and a housing lower part;
a foam structure;
a support structure disposed between the foam structure and the housing lower part; and
a multiplicity of energy storage cells embedded in the foam structure;
wherein an upper side of the foam structure is foam-bonded to the housing upper part, and a lower side of the foam structure is foam-bonded to a fluid-tight arrangement surface of the support structure; and
wherein the foam structure includes lateral faces which are formed by way of a tool contour and/or by foam-bonding to one or a plurality of lateral walls which are connected to the support structure in a fluid-tight manner.

17. The electric energy storage device according to claim 16, wherein the energy storage cells are disposed so as to be spaced apart from the fluid-tight arrangement surface by way of a multiplicity of spacer elements.

18. The electric energy storage device according to claim 16, wherein the fluid-tight arrangement surface is formed by an additional element which is disposed on the support structure.

19. The electric energy storage device according to claim 17, wherein the fluid-tight arrangement surface is formed by an additional element which is disposed on the support structure.

20. The electric energy storage device according to claim 16, wherein the support structure is adhesively bonded to the housing lower part, which has a tub-shape.

21. The energy storage device according to claim 16, further comprising two mutually opposite lateral walls which extend along a vertical axis, wherein a first lateral wall of the two mutually opposite lateral walls includes a coolant conductor, and wherein a second lateral wall of the two mutually opposite lateral walls includes an electric current conductor.

22. The energy storage device according to claim 16, wherein the support structure is assembled in a fluid-tight manner from a multiplicity of segments.

23. The energy storage device according to claim 22, wherein the two mutually opposite lateral walls are assembled in a fluid-tight manner from a multiplicity of portions.

24. The energy storage device according to claim 23, wherein cutting elements and/or form-fitting elements are disposed between or on the segments and/or the portions for establishing fluid-tight connections.

25. A motor vehicle comprising an electric energy storage device according to claim 16.

26. A method for producing an electric energy storage device, the method comprising:
providing a support structure that includes a fluid-tight arrangement surface;
disposing a multiplicity of energy storage cells on the fluid-tight arrangement surface;
disposing, in a fluid-tight manner, one or a plurality of lateral walls on the support structure and/or using one or a plurality of tools for shaping a cavity for a foam structure for embedding the energy storage cells;
incorporating a foaming-capable fluid into the cavity; and
closing the cavity by disposing a housing upper part of the energy storage device.

27. The method according to claim 26, further comprising:
assembling the support structure from a multiplicity of segments.

28. The method according to claim 27, wherein energy storage cells are disposed on the segments.

29. The method according to claim 27, wherein cooling elements and/or lateral wall portions are disposed on the segments.

30. The method according to claim 28, wherein cooling elements and/or lateral wall portions are disposed on the segments.

31. The method according to claim 26, further comprising:
connecting, in a fluid-tight manner, the segments, the lateral walls and/or the portions by envisaging form-fitting and/or cutting elements which provide fluid-tightness between the segments, the lateral walls and/or the portions.

32. The method according to claim 29, further comprising:
fastening, in an integral manner, a housing lower part of the energy storage device to the support structure.
